(19) United States
(12) Patent Application Publication
(10) Pub. No.: US 2007/0208157 A1
(43) Pub. Date: Sep. 6, 2007

(54) Polyurea polymers with improved flexibility using secondary polyetheramines

(75) Inventors: Mark L. Posey, Spring, TX (US); Kenneth M. Hillman, Spring, TX (US)

Correspondence Address: Legal Department;Huntsman Corporation, 10003 Woodloch Forest Drive, The Woodlands, TX, 77380, US

(73) Assignee: Huntsman Petrochemical Corporation, The Woodlands, TX (US)

(21) Appl. No.: 11/365,726

(22) Filed: Mar. 1, 2006

(51) Int. Cl. C08G 18/00

(52) U.S. Cl. 528/44

(57) ABSTRACT

Provided herein are polymers, including polyureas, polyurethanes, and polyurea-polyurethane hybrids, made from an isocyanate, a secondary polyetheramine, an aspartic ester amine, and optionally a polyol. The secondary polyetheramine may be used in combination with the aspartic ester amine to increase flexibility or modify other properties and lower cost of the final polymer product while maintaining a desirable cure time.

### FIELD OF THE INVENTION

The present invention relates generally to polymers. More specifically, it relates to the preparation of polymeric reaction products formed from the reaction between an isocyanate, a secondary polyetheramine, an aspartic ester amine and optionally a polyol.

### BACKGROUND INFORMATION

Polymers can be formed from the reaction of one or more isocyanates with one or more amines. These polymers can be formed by bringing the isocyanates in contact with the amines using static mixing equipment, high-pressure impingement mixing equipment, low-pressure mixing equipment, roller with mixing attachments and simple hand mixing techniques. These polymers are useful in caulks, adhesives, sealants, coatings, foams, and many other applications. Specific examples include, but are not limited to, truck-bed liners, concrete coatings, and molded articles.

One amine that is used to form these polymers is aspartic ester amine. This amine has the advantage of having a slow cure time. However, its use has many disadvantages. For instance, the slowest aspartic ester amine forms polymers that are highly brittle when used as the only chain extender. In addition, it has a much higher viscosity than most other amine curing agents. Higher viscosities can result in higher pressure differentials when spraying, leading to poor mixing and reduced coating properties. Aspartic ester amine has the added disadvantage of being an expensive component of the polymer. Many approaches have tried to overcome these disadvantages with limited success. To reduce brittleness, more flexible aspartic ester amines have been developed. However, the flexible aspartic ester amines do not provide any viscosity or cost benefits. Hard block aromatic amines or primary aliphatic amines have been tried as well. Using hard block aromatic chain extenders does not improve brittleness. Primary aliphatic amines can lessen brittleness, but they have the disadvantage of decreasing the cure time and therefore making them undesirable for many applications.

### SUMMARY OF THE INVENTION

Embodiments of the present invention disclose a process for forming a polymer by providing a first component having at least one isocyanate and a second component having at least one secondary polyetheramine and at least one aspartic ester amine. The first component and the second component are contacted so as to form the polymer. Other embodiments disclose a process that further has at least one polyol in the first or second component, or in both.

Another embodiment further discloses a polymer made by the process of providing a first component having at least one isocyanate and a second component having at least one secondary polyetheramine and at least one aspartic ester amine. The first component and the second component are then contacted so as to form the polymer. In yet another embodiment, a reduced amine mixture is disclosed that has an aspartic ester amine and at least one secondary polyetheramine.

By using secondary polyetheramines, the brittleness of the polymers may be controlled while still maintaining a desirable cure time. In addition, the viscosity of the amine blend may be reduced as well as other properties modified. By replacing part of the aspartic ester amines with secondary polyetheramines, the cost of the final polymer may also be reduced.

### DETAILED DESCRIPTION

According to the present invention, secondary polyetheramines are employed in the production of polymers. In this disclosure, a polymer shall include, but not be limited to, polyureas, polyurethanes, and polyurea-polyurethane hybrids. One skilled in the art will recognize other polymer applications for teachings of this invention.

Embodiments of the present invention include a polymer produced by using a first component having at least one isocyanate and a second component having at least one secondary polyetheramine and at least one aspartic ester amine.

The first component has at least one isocyanate. As used in the present specification and the appended claims, the term “isocyanate” includes a wide variety of materials recognized by those skilled in the art as being useful in preparing polyurea and polyurethane polymer materials. Included within this definition are both aliphatic and aromatic isocyanates, as well as one or more prepolymers or quasi-prepolymers prepared using such isocyanates as a starting material, as is generally well known in the art. Preferred examples of aliphatic isocyanates are of the type described in U.S. Pat. No. 4,748,192, as well as aliphatic di-isocyanates and, more particularly, the trimerized or the biuretic form of an aliphatic di-isocyanate, such as hexamethylene di-isocyanate (“HDI”), and the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. They include aliphatic di-isocyanates, for example, alkylene di-isocyanates with 4 to 12 carbon atoms in the alkylene radical, such as 1,12-dodecane di-isocyanate, 1,4-tetramethylene di-isocyanate, and 1,6-hexamethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate, H₁₂ MDI (methylene bisphenyl isocyanate), hydrogenated MDI as well as the corresponding isomer mixtures, and the like.

A wide variety of aromatic polyisocyanates may also be used to form a polymer according to the present invention, and typical aromatic polyisocyanates include p-phenylene di-isocyanate, polymethylene polyphenylisocyanate, 2,6-toluene di-isocyanate, dianisidine di-isocyanate, 2,4-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl)methane, and 4,4′-diphenylpropane di-isocyanate, as well as MDI-based quasi-prepolymers, including without limitation 2,4 methylene bisphenyl isocyanate and 4,4′ methylene bisphenyl isocyanate, such as those available commercially as RUBINATE® 9480 MDI, RUBINATE® 9484 MDI, and RUBINATE® 9495 MDI from Huntsman International, LLC.

Other aromatic polyisocyanates used in the practice of the invention are methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Usually methylene-bridged polyphenyl polyisocyanate mixtures contain about 20 to about 100 weight percent methylene di-phenyl-di-isocyanate isomers, with the remainder being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. The present invention includes the use of mixtures of isomers of isocyanates, which are produced simultaneously in a phosgenation reaction, or any blend of two or more isocyanates (including two or more mixtures of isocyanates, or a single isocyanate with a mixture of isocyanates) which are produced using two or more separate phosgenations. One preferred aromatic polyisocyanate is methylene bis(4-phenylisocyanate) or “MDI”. Pure MDI, quasi-prepolymers of MDI, modified pure MDI, etc. are useful to prepare materials according to the invention. Since pure MDI is a solid and, thus, often inconvenient to use, liquid products based on MDI or methylene bis(4-phenylisocyanate) are also useful herein. U.S. Pat. No. 3,394,164 describes a liquid MDI product. More generally, uretonimine modified pure MDI is included also. This product is made by heating pure distilled MDI in the presence of a catalyst. The liquid product is a mixture of pure MDI and modified MDI. The term isocyanate also includes quasi-prepolymers of isocyanates or polyisocyanates with active hydrogen containing materials. Any of the isocyanates mentioned above may be used as the isocyanate component in the present invention, either alone or in combination with other aforementioned isocyanates. One skilled in the art with the benefit of this disclosure will recognize suitable isocyanates to use for a particular application.

The second component has at least one secondary polyetheramine and at least one aspartic ester amine. The secondary polyetheramines may be obtained by reacting primary polyetheramines with a di-alkyl ketone, aldehyde, or cyclic ketone or other carbonyl-function containing molecule in the presence of hydrogen and a catalyst. The secondary polyetheramines so obtained are typically light in color, have low viscosities, and remain liquid at room temperature, which is a marked advantage which will be greatly appreciated by industrial producers of polymers.

The term “secondary polyetheramines” when used in this specification and the claims appended hereto means those secondary amines within the definitions of formula: 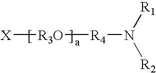
in which R₁ and R₂ are each independently selected from the group consisting of: hydrogen; an alkyl group having 1, 2, 3, 4, 5, 6, 7, 8, 9, or 10 carbon atoms, whether straight-chain or branched; or cyclic; or a radical of the formula: 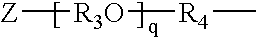
in which R₃ in each occurrence may be an alkyl group having any number of carbon atoms selected from 1, 2, 3, 4, 5, or 6, straight-chain or branched; R₄ in each occurrence is a straight-chain or branched alkyl bridging group having 1, 2, 3, 4, 5, or 6 carbon atoms; Z is a hydroxy group or alkyl group containing 1, 2, 3, 4, 5, or 6 carbon atoms, straight-chain or branched; q is any integer between 0 and 400; and wherein X is any of:

i) a hydroxy group or an alkyl group having any number of carbon atoms selected from 1, 2, 3, 4, 5, or 6; or

ii) a group 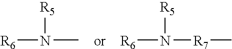
in which R₅ and R₆ are each independently selected from the group consisting of: hydrogen; an alkyl group having 1, 2, 3, 4, 5, 6, 7, 8, 9, or 10 carbon atoms, whether straight-chain or branched; or cyclic; or 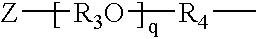
as defined above in which Z is a hydroxy group or an alkoxy group having 1, 2, 3, 4, 5, or 6 carbon atoms, and in which R₇ is a straight-chain or branched alkylene bridging group having 1, 2, 3, 4, 5, or 6 carbon atoms; or

iii) a moiety of the formula: 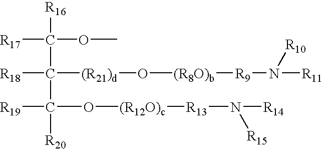
in which R₁₀, R₁₁, R₁₄, and R₁₅ are each independently selected from the group of: hydrogen; an alkyl group having 1, 2, 3, 4, 5, 6, 7, 8, 9, or 10 carbon atoms, straight-chain or branched; or cyclic; the moiety

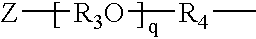

as defined above in which Z is a hydroxy or alkoxy group having 1, 2, 3, 4, 5, or 6 carbon atoms; R₈ and R₁₂ are each independently alkyl groups having 1, 2, 3, 4, 5, or 6 carbon atoms, straight-chain or branched; R₉, R₁₃, and R₂₁ are each independently selected from a straight-chain or branched alkyl bridging linkage having 1, 2, 3, 4, 5, or 6 carbon atoms; R₁₆, R₁₇, R₁₈, R₁₉, R₂₀ are each independently selected from hydrogen or an alkyl group having 1, 2, 3, 4, 5, or 6 carbon atoms; d is 0 or 1; a is any integer between 0 and 100, with the proviso that when X is a moiety of the formula given in iii) above, b and c may each independently be any integer in the range of 0 to 390, and the sum of a+b+c is any number between 2 and 400. According to one preferred form of the invention, such secondary polyetheramines are diamines. According to another form of the invention, such secondary polyetheramines are triamines. Secondary polyetheramines of the present invention are not limited their functionality.

The secondary polyetheramines may comprise secondary polyoxyalkylene amines. The secondary polyoxyalkylene amines are commercially available from Huntsman Petrochemical Corporation of The Woodlands, Tex. under the designations XTJ-584, XTJ-585, XTJ-576 and XTJ-586. These chemicals have the general structure:

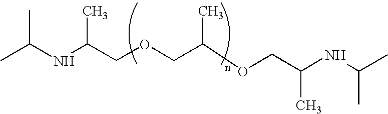

| | | |
|---|---|---|
| XTJ-584 (D-230): | n = ca. 1.7 | Avg MW˜314 |
| XTJ-585 (D-400): | n = ca. 5.1 | Avg MW˜512 |
| XTJ-576 (D-2000): | n = ca. 30.9 | Avg MW˜2007 |

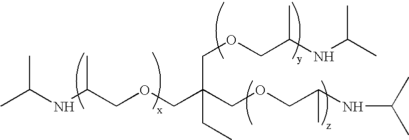

| | | |
|---|---|---|
| XTJ-586 (T-403): | x + y + z = ca. 5.3 | Avg MW˜567 |

One skilled in the art, with the benefit of this disclosure will recognize other appropriate secondary polyetheramines to use in embodiments of this invention.

The second component also comprises an aspartic ester amine. Aspartic ester amines are desirable for slower cure speeds. They may comprise molecules with the following formula: 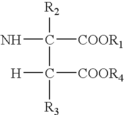
wherein R1 and R4 may be identical or different and represent an organic group, such as methyl or ethyl, and wherein R2 and R3 may be identical or different and represent an organic group or hydrogen. Aspartic ester amines are commercially available from Bayer MaterialScience LLC of Pittsburgh, Pa. under the tradename DESMOPHEN®.

In embodiments of the present invention, properties of the polymer can be adjusted through proper control of the ratio of secondary polyetheramines to aspartic ester amines. When using too much secondary polyetheramine, it will take over as the rate controlling curing agent and then the point of using aspartic ester amine is lost. When the secondary polyetheramine takes over as the rate controlling curing agent varies widely depending on formulation considerations. Increasing the level of secondary polyetheramine may increase the flexibility of the polymer while not appreciably adjusting the overall cure time. The reduction in the speed of the reaction of the secondary polyetheramines during production of polymers according to the present invention is an advantage of embodiments of the present invention which enables formation of molded articles and coatings having higher structural integrity, especially in the end use of coatings, in which superior tear strengths heretofore unobserved in these coatings have been attained. Increased work time through the slower cure rate allows for smoother and glossier coatings to form, which are also aesthetically more appealing. Slower reaction rates allow for production of caulk and sealant formulations having sufficient gel time for practical use. Longer working times will also have benefit in adhesive and sealant applications where having more time to bring two surfaces into contact is critical to success. Also since polyetheramines may be a fraction of the cost of aspartic ester amines, production costs can be saved by using secondary polyetheramines as a substitute for aspartic ester amines. The secondary polyetheramines may also reduce the mixture viscosity versus using aspartic esters alone which has benefits in the application of the polymers. In embodiments of the present invention, the ratio of the secondary polyetheramine parts to the aspartic ester amine parts, not including any other parts of the compositions and wherein both parts equal 100, may range from about 0.1:99.9 to about 99.9:0.1. In other embodiments of the present invention, the ratio of the secondary polyetheramine to the aspartic ester amine is from about 5:95 to about 75:25. In another embodiment, the ratio of the secondary polyetheramine to the aspartic ester amine is from about 5:95 to about 50:50. Other embodiments allow ratios of 1:99 to 40:60, 1:99 to 30:70; 1:99 to 25:75; 1:99 to 20:80; and all ratios in between those previously listed. One skilled in the art, with the benefit of this disclosure will recognize an appropriate ratio of secondary polyetheramine to aspartic ester amine in order to produce a polymer with a specific flexibility, cure time, and cost.

In embodiments of the present invention, the first or second component, or both, may further comprises at least one polyol. Polyols may include, without limitation, polyether polyols, polyester polyols, polycarbonate polyols, other polyols, polyol chain extenders such as 1,4-butane diol catalyst. When a polyol is used, a hybrid polymer is formed such as a polyurea-polyurethane hybrid polymer. This invention teaches the use of secondary polyetheramines and aspartic ester amines in such hybrid polymers. One skilled in the art, with the benefit of this disclosure will recognize other suitable polyols for use in this invention.

In another embodiment of the present invention, additives may be used for the first or second component, or in both. The additives may include primary polyetheramines such as JEFFAMINE® D-2000 amines and JEFFAMINE® T-5000 amines; primary amine chain extenders such as 3-aminomethyl-3,5,5-trimethylcyclohexylamine (also known as IPDA or Isophorone Diamine), diethyl toluene diamine (also known as DETDA, CAS No. 68479-98-1, which is commercially available from the Albemarle Corporation of Baton Rouge, La. under the tradename ETHACURE® 100 curative), dimethylthio toluene diamine (also known as DMTDA, CAS No. 106264-79-3, which is commercially available from the Albemarle Corporation of Baton Rouge, La. under the tradename ETHACURE® 300 curative); secondary amine chain extenders (that are not secondary polyetheramines or aspartic ester amines) such as N,N′-dialkylamino-diphenylmethane (commercially available from Dorf Ketal Chemicals, LLC of Stafford, Tex. under the tradename UNILINK 4200® diamines), Bis(N-sec butylaminocyclohexyl)methane (commercially available from Dorf Ketal Chemicals, LLC of Stafford, Tex. under the tradename CLEARLINK® 1000 diamines), Bis(N-sec butyl 3-methyl aminocyclohexyl) methane (commercially available from Dorf Ketal Chemicals, LLC of Stafford, Tex. under the tradename CLEARLINK® 3000 diamines), N,N′-isopropyl (3-aminomethyl-3,5,5-trimethylcyclohexylamine) (commercially available from Huntsman Petrochemical Corporation under the tradename JEFFLINK® 754 diamines), 1,3 bis Aminomethyl cyclohexane, and its secondary amine byproducts from alkylation with ketones; pigments; anti-oxidant additives; surface active additives; thixotropes; adhesion promoters; UV absorbers; derivatives thereof and combinations thereof. UNILINK 4200® and CLEARLINK® are registered trademarks of Dorf Ketal Chemicals, LLC of Stafford, Tex. JEFFLINK® is a registered trademark of Huntsman Petrochemical Corporation of The Woodlands, Tex. ETHACURE® is a registered trademark of the Albemarle Corporation of Baton Rouge, La. One skilled in the art, with the benefit of this disclosure, will recognize other suitable additives for use in the polymers and processes of the present invention.

In other embodiments of the present invention, a process is disclosed for the formation of a polymer. The process includes contacting the first component and the second component so as to form the polymer. To provide a polymer according to the present invention, a first component having isocyanate is mixed with a second component having secondary polyetheramine and aspartic ester amine, either manually or automatically, using conventional production equipment. Typically, during the manufacturing process for producing polymers according to the prior art, the first and second components are normally kept separated from one another, such as by being contained in separate containers, until being mixed at the time of use. The second component is typically a blend of amines, pigments and other additives, and is sometimes referred to by those skilled in the art as the “resin blend”. The resin blend is usually prepared in advance of the mixing of the first component and the second component, and well mixed to ensure uniform dispersion of the pigments and amines, using mixing techniques which are known to those skilled in the art. The polymers can be formed by any number of ways known to those skilled in the art such as high-pressure impingement mix spraying, low pressure static-mix spray, low pressure static mix dispensing (caulk gun), hand techniques (including mixing by hand or hand tools and then applying the mixture manually with a brush, rollers, or other means), methods described in the background, and combinations thereof. One skilled in the art, with the benefit of this disclosure will recognize suitable methods of contacting the first and second components.

In an embodiment of the present invention, a reduced viscosity amine mixture (resin blend) is disclosed. In another embodiment, a method is disclosed to reduce viscosity of an amine mixture (resin blend). The amine mixture, if using aspartic ester amine alone, may be too viscous for many applications. By adding secondary polyetheramine to the aspartic ester amine, the viscosity if the mixture may be reduced to a desired level. One skilled in the art with the benefit of this disclosure will recognize appropriate amounts of secondary polyetheramine to achieve amine mixtures with desired viscosities.

Polymers produced according to methods of the present invention are suitable for a wide range of end uses, including without limitation, the following: coatings for concrete, coatings over geotextile, spray on coatings, bridges, bridge pylons, bridge decks, water-proofing layers, tunnels, manholes, fish ponds, secondary containment, skid resistant layers, flooring, garages, aircraft hangars, sewer rehabilitation, water pipes, concrete pipes; coatings for metals, including masking layer for etching process, corrosion protection, ship hulls, ship decks, aircraft carrier decks, submarines, other military vehicles, helicopter rotor blades, bridges, structural members, playgrounds, automotive, truck-bed liners, under-carriage, outer body, rail-road cars and hoppers, trailers, flat bed trucks, 18 wheelers, large dirt moving equipment, rollers, aerospace, tank coatings (inside and out), pipe coating (inside and out); coatings for other substrates such as fiberglass boats, pavement marking, concrete marking, decorative/protective layer over various substrates for movie sets, amusement parks, parade floats, paint-ball props, electronics encapsulation, roofing topcoat for various substrates; coatings for polystyrene, wax, ice, or other media used in prototyping; manufacture of molded articles, such as reaction injection molded and products made using other molding techniques, prototype parts, shoe components, golf balls, decorative parts, automotive parts, bumpers, hubcaps; polyurea foam for sound insulation; thermal insulation; shock absorption; and other end use applications where polyurethane foam is known to be useful in the various arts; caulks for concrete floors and other architectural applications in which a sealant is employed, adhesives for bonding two components in a wide variety of substrates and applications where adhesives are normally employed; and sealants for a wide variety of non-architectural applications, such as on board of sea-going vessels. One skilled in the art, with the benefit of this application will recognize other appropriate uses for embodiments of this invention.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

### Experimental

Techniques

Throughout this specification various test results are set forth, and the following test methods were employed in each occurrence of the following herein:

| Test | Method |
|---|---|
| Tensile strength | ASTM D-638 |
| Max Elongation | ASTM D-638 |
| Tear Strength | ASTM D-624 |
| String Gel | see below |
| Tack Free Time | see below |

The string gel and tack free time test methods are now described. The methods used depend upon the method of preparing the polymer polymers. For the spray method, a vertical surface is used as a target, which is typically a piece of cardboard or other disposable material. The spray gun is triggered to dispense polymer onto the cardboard at the same time as the stop watch is started. Spray is continued until sufficient material has built up to begin running downward. This is usually less than 2 seconds. “Gel Time” is the elapsed time from the start of the watch until the polymer material is no longer running down the vertical surface, i.e. the polymer has gelled to the point that it no longer flows under gravity. “Tack Free” is the time elapsed when the polymer surface is no longer sticky when touched by a gloved finger with light pressure.

Formulations 8349-6 and 8349-8 were created by static mix technique. All other data was from high pressure impingement mixing spray. For the preparation of samples using the high pressure impingement mixing spray method, a GUSMER® Marksman (or H20/35) proportioning unit (plural component) was used, fitted with a GUSMER® GX-7-400 spray gun. The equipment was set so as to process each example at a first to second component volume ratio of 1.00. Spray processing pressure was maintained at 1500 psi to 2500 psi on both the first and second components. Block heat, as well as hose heat, was set at 160° F.

For the static mix method, because static mix samples are normally dispensed into a horizontal mold, and therefore don't run, a different measurement is used and called “String gel” rather than just “Gel”. The stopwatch is started when the polymer is begun to be dispensed into the mold. The polymer surface in the area first coated is then touched lightly with a wooden tongue depressor and then lifted vertically. The test area must be from the first material because as many as 10-20 seconds can pass from the start to the end of dispensing of the polymer into the mold. In the early stages of cure, the polymer will stick to the depressor and rise up with the vertical motion pulling a “string” which eventually breaks loose. The touch and lift procedure is repeated until such time as the polymer surface no longer pulls vertically with the tongue depressor. The surface can still be tacky and soft at this point. “Tack Free” is the time elapsed at which point the polymer surface is no longer sticky when touched by a gloved finger with light pressure. Also, light pressure with a gloved finger should not create a “fingerprint” or depression in the surface. Even though the surface is “tack free” it may not be strong enough at this point to take a significant force without flowing or deforming. The viscosity was measured in centistrokes (cSt) at 25° C.

In the tables which follow, the “A side” refers to the first component and the “B side” refers to the second component. Under the A side: DESMODUR® N-3400 polyisocyanate is an HDI trimer isocyanate available from Bayer MaterialScience, LLC of Pittsburgh, Pa., XTJ-576 is di-isopropyl substituted JEFFAMINE® D-2000 amine; and RUBINATE® 9480 MDI is a isocyanate. Under the B side: JEFFAMINE® D-2000 amine is a primary amine, XTJ-584 is di-isopropyl substituted JEFFAMINE® D-230 diamine; product XTJ-585 is di-isopropyl substituted JEFFAMINE® D-400 diamine, DESMOPHEN® NH 1420 amine is an aspartic ester amine, JEFFLINK® 754 amine is a chain extender, TiO₂ is a pigment, JEFFAMINE® T-5000 amine is a primary amine with functionality between 2 and 3, ETHACURE® 100 curative is a diethyl toluene diamine, D230-CycC6 is a an experimental secondary polyetheramine based upon the alkylation of our JEFFAMINE® D-230 diamine with cyclohexanone, and T403-CycC6 is a trifunctional secondary polyetheramine based up JEFFAMINE® T-403 amine alkylated with cyclohexanone. JEFFAMINE® M-600 amine, (XTJ-505) is a primary monoamine.

Comparisons

Table 1 shows three comparison pairs: 8349-6/8 are a comparison pair; 8349-24/25 are a comparison pair; and 8349-21/75 are a comparison pair. Table 2 shows a comparison trio between 8349-66/8349-71/8349-72. Table 3 shows a comparison quartet between 8391-8, 8391-9, 8391-15, and 8391-16.

Comparison Pair 8349-6/8

Formulation 8349-6 has a long cure time which can be desirable, however, it's very low elongation of 10% results in brittle coatings. By replacing some of the DESMOPHEN® NH 1420 amine (aspartic ester amine) with XTJ-585 (a secondary polyetheramine), the elongation improved to 145%, the hardness was still high at 71 Shore D, and the gel time was 10 min compared to 27 minutes. In practical terms, these two cure times are the same and allow the two coatings to be applied in the same way using the same equipment. The drop in tensile strength was expected with the increase in elongation.

Comparison Pair 8349-24/25

Formulation 8349-24 is very similar to 8349-6 except that this coating has been formed from high pressure impingement mixing spray and contains pigment. The gel time was 120 seconds, which is good for obtaining high gloss coatings, however, it also restricts the film thickness as additional material would just run down vertical surfaces. Again by replacing some of the DESMOPHEN® NH 1420 amine (aspartic ester amine) with XTJ-585 (secondary polyetheramine) in formulation 8349-25, the elongation improved from 17% to 152%, the hardness was still high at 63 Shore D, and the gel time was 32 seconds. Although this cure speed is faster than 120 seconds, any cure speed above 20 seconds for spray coatings is effectively the same and slower curing just further limits coating thickness in a single pass.

Comparison Pair 8349-21/75

Another drawback of the DESMOPHEN® NH 1420 amine (aspartic ester amine) is its low equivalent weight. At isocyanate concentrations above 17.5% NCO, the DESMOPHEN® NH 1420 amine does not have sufficient amine content to balance with the isocyanate equivalents, at Iso/Amine ratios below 1.20 in an equal volume spray application. DESMODUR® N-3400 polyisocyanate is an HDI trimer based aliphatic isocyanate that can produce very hard coatings with good properties. DESMOPHEN® NH 1420 amine cannot be used to cure this isocyanate on its own due to its low equivalent weight. By replacing the DESMOPHEN® NH 1420 amine (aspartic ester amine) with JEFFLINK® 754 amine and XTJ-584 (a secondary polyetheramine), an excellent coating can be formed while still having reasonable cure times. Formulations 8349-21 and 8349-75 are examples of this point. 8339-21 demonstrates a cure time of 11 seconds with high hardness and tensile strength. Elongation could have been improved by using slightly less JEFFLINK® 754 amine and slightly more XTJ-584 or XTJ-585. Formulations such as these would not be possible using only DESMOPHEN® NH 1420 amine (aspartic ester amine) or JEFFLINK® 754 amine alone.

Comparison Trio 8349-66, 8349-71 and 8349-72

Formulations 8349-66, 8349-71 and 8349-72 demonstrate using secondary amines to moderate the cure speed of aromatic polyurea coatings. Formulation 66 shows the effects of using DESMOPHEN® NH 1420 amine. Formulation 8349-71 completely replaces the DESMOPHEN® NH 1420 amine (aspartic ester amine) with an experimental secondary polyetheramine D230-CycC6. Note that elongation improved from 396% to 688% with an expected hardness drop from 60 to 43 Shore D. Most surprisingly is that the gel time actually increased, 10 seconds to 14 seconds, when replacing DESMOPHEN® NH 1420 amine with a secondary polyetheramine. Formulation 8349-72 demonstrates the effect of using the trifunctional secondary polyetheramine T403-CycC6. Due to the additional crosslinking the elongation did not change much, 396% to 356% and the cure speed was also very similar at 9 seconds versus 10 seconds. Hardness did drop due to the use of a flexible polyetheramine.

Comparison Quartet 8391-8, 8391-9, 8391-10, and 8391-11

Formulations 8391-8, 8391-9, 8391-10, and 8391-11 demonstrate the reduction in viscosity using secondary polyetheramines compared with using aspartic ester amines alone. Formulation 8391-8 is the control sample of just aspartic ester amine and has a viscosity of 1188. In formulation 8391-9, 5% of the aspartic ester amine has been replaced with JEFFAMINE® M-600 amine. The resulting viscosity was 846, roughly one third less than the viscosity of the control sample. Formulations 8391 -10 and 8391 -11 demonstrate a further reduction in viscosity by reducing the amount of aspartic ester amine. Formulation 8391-10 has 80% aspartic ester amine and 20% XTJ-585. This formulation has a viscosity of 363, which is two thirds less than the viscosity of the control sample. Formulation 8391 -11 has 55% aspartic ester amine, 20% XTJ-584 and 25% JEFFLINK® 754 amine. This formulation has a viscosity of 84 which is a dramatic decrease from the control sample's viscosity of 1188.

TABLE 1

| | Sample No. | | | | | |
|---|---|---|---|---|---|---|
| | 8349-6 | 8349-8 | 8349-24 | 8349-25 | 8349-21 | 8349-75 |
| A Side | | | | | | |
| DESMODUR ® N-3400 | 85 | 85 | 85 | 85 | 100 | 100 |
| polyisocyanate | | | | | | |
| XTJ-576 | 15 | 15 | 15 | 15 | 0 | 0 |
| % NCO | 17.4 | 17.4 | 17.4 | 17.4 | 21.76 | 21.71 |
| B Side | | | | | | |
| JEFFAMINE ® D-2000 | 0 | 0 | 0 | 0 | 0 | 0 |
| amine | | | | | | |
| XTJ-584 | 0 | 0 | 0 | 0 | 20 | 20 |
| XTJ-585 | 0 | 30 | 0 | 20 | 0 | 0 |
| DESMOPHEN ® NH | 88 | 52 | 83 | 60 | 55 | 43 |
| 1420 amine | | | | | | |
| JEFFLINK ® 754 | 12 | 18 | 12 | 15 | 25 | 32 |
| amine | | | | | | |
| TiO2 | 0 | 0 | 5 | 5 | 0 | 5 |
| Volume Ratio | 1 | 1 | 1 | 1 | 1 | 1 |
| Wt Ratio(iso/resin) | 1.068 | 1.127 | 1.033 | 1.067 | 1.155 | 1.131 |
| Index (NCO/N) | 1.079 | 1.065 | 1.091 | 1.087 | 1.159 | 1.12 |
| Tensile Strength, psi | 6352 | 1966 | 4488 | 2349 | 5060 | 6309 |
| Max Elongation, % | 10 | 145 | 17 | 152 | 15 | 14 |
| 100% Modulus, psi | N/A | 1690 | N/A | 2006 | N/A | N/A |
| 300% Modulus, psi | N/A | N/A | N/A | N/A | N/A | N/A |
| Youngs Modulus, psi | 74776 | 20216 | 54915 | 29085 | 64122 | 80055 |
| Tear Strength, pli | 850 | 486 | 649 | 554 | 740 | 381 |
| Shore D, 0 sec/10 sec | 76/70 | 71/57 | 70/65 | 63/52 | 74/68 | 73/69 |
| String Gel, sec @ 25 C. | 27 min | 10 min | N/A | N/A | N/A | N/A |
| Tack Free, sec @ 25 C. | <18 hrs | <22 hrs | N/A | N/A | N/A | N/A |
| Spray, Gel Time, sec | N/A | N/A | 120 | 32 | 11 | 5 |
| Tack Free, sec | N/A | N/A | 2 hrs | 40-60 min | 300 | 205 |

TABLE 2

| | Sample No. | | |
|---|---|---|---|
| | 8349-66 | 8349-71 | 8349-72 |
| A Side | | | |
| RUBINATE ® 9480 MDI | 100 | 100 | 100 |
| % NCO | 15.5 | 14.87 | 14.87 |
| B Side | | | |
| JEFFAMINE ® D-2000 amine | 26 | 39 | 26 |
| JEFFAMINE ® T-5000 amine | 10 | 10 | 10 |
| ETHACURE ® 100 curative | 14 | 14 | 14 |
| D230-CycC6 | 0 | 32 | 0 |
| T403-CycC6 | 0 | 0 | 45 |
| DESMOPHEN ® NH 1420 amine | 45 | 0 | 0 |
| TiO2 | 5 | 5 | 5 |
| Volume Ratio | 1 | 1 | 1 |
| Wt Ratio(iso/resin) | 1.071 | 1.116 | 1.115 |
| Index (NCO/N) | 1.125 | 1.113 | 1.104 |
| Tensile Strength, psi | 2229 | 1832 | 1621 |
| Max Elongation, % | 396 | 688 | 356 |
| 100% Modulus, psi | 1439 | 837 | 968 |
| 300% Modulus, psi | 1916 | 1110 | 1428 |
| Youngs Modulus, psi | 20595 | 9749 | 11196 |
| Tear Strength, pli | 475 | 473 | 329 |
| Shore D, 0 sec/10 sec | 60/51 | 43/32 | 44/34 |
| Spray, Gel Time, sec | 10 | 14 | 9 |
| Tack Free, sec | 27 | 40 | 16 |

TABLE 3

| | WT % | WT % | WT % | WT % |
|---|---|---|---|---|
| Viscosity Blends | Blend | Blend | Blend | Blend |
| DESMOPHEN ® NH 1420 | 100 | 95 | 80 | 55 |
| amine | | | | |
| JEFFLINK ® 754 amine | 0 | 0 | 0 | 25 |
| XTJ-584 | 0 | 0 | 0 | 20 |
| XTJ-585 | 0 | 0 | 20 | 0 |
| JEFFAMINE ® M-600 amine | 0 | 5 | 0 | 0 |
| SAMPLE | 8391-8 | 8391-9 | 8391-10 | 8391-11 |
| Viscosity, cSt @ 25° C. | 1188 | 846 | 363 | 84 |

What is claimed is:

1) A process for producing a polymer comprising:
providing a first component having at least one isocyanate;
providing a second component having at least one secondary polyetheramine and at least one aspartic ester amine; and
contacting the first component and the second component so as to form the polymer.

2) A process according to claim 1 wherein the ratio of the at least one secondary polyetheramine to the at least one aspartic ester amine ranges from about 0.1:99.9 to about 99.9:0.1.

3) A process according to claim 1 wherein the ratio of the at least one secondary polyetheramine to the at least one aspartic ester amine ranges from about 5:95 to about 75:25.

4) A process according to claim 1 wherein the ratio of the at least one secondary polyetheramine to the at least one aspartic ester amine ranges from about 5:95 to about 50:50.

5) A process according to claim 1 wherein the ratio of the at least one secondary polyetheramine to the at least one aspartic ester amine ranges from about 1:99 to about 40:60.

6) A process of claim 1 wherein the first component, second component, or first component and second component further comprise at least one polyol.

7) A process of claim 6 wherein the polyol is selected from the group consisting of: a polyether polyol, a polyester polyol, a polycarbonate polyol, and a polyol chain extender.

8) A process according to claim 1 wherein the second component further comprises at least one amine selected from the group consisting of: N,N′-dialkylamino-diphenylmethane, Bis(N-sec butylaminocyclohexyl)methane, Bis(N-sec butyl 3-methyl aminocyclohexyl) methane, N,N′-isopropyl (3-aminomethyl-3,5,5-trimethylcyclohexylamine), 3-aminomethyl-3,5,5-trimethylcyclohexylamine, diethyl toluene diamine, dimethylthio toluene diamine, 1,3 bis Aminomethyl cyclohexane, secondary amine byproducts from alkylation of 1,3 bis Aminomethyl cyclohexane, derivatives thereof and combinations thereof.

9) A process according to claim 1 wherein the second polyetheramine comprises a secondary monoamine.

10) A process according to claim 1 wherein the second polyetheramine comprises a secondary diamine.

11) A process according to claim 1 wherein the secondary polyetheramine comprises a secondary polyoxyalkylene amine.

12) A process according to claim 1 wherein the second polyetheramine comprises a secondary triamine.

13) A process according to claim 1 wherein the first component, second component, or first component and second component further comprise at least one additive.

14) A polymer produced by:
providing a first component having at least one isocyanate;
providing a second component having at least one secondary polyetheramine and at least one aspartic ester amine;
contacting the first component and the second component so as to form the polymer.

15) A process according to claim 14 wherein the secondary polyetheramine is selected from the group consisting of: a secondary monoamine, a monoamine, derivatives thereof and combinations thereof.

16) A process according to claim 14 wherein the second component comprises at least one amine selected from the group consisting of: N,N′-dialkylamino-diphenylmethane, Bis(N-sec butylaminocyclohexyl)methane, Bis(N-sec butyl 3-methyl aminocyclohexyl) methane, N,N′-isopropyl (3-aminomethyl-3,5,5-trimethylcyclohexylamine), 3-aminomethyl-3,5,5-trimethylcyclohexylamine, diethyl toluene diamine, dimethylthio toluene diamine, 1,3 bis Aminomethyl cyclohexane, secondary amine byproducts from alkylation of 1,3 bis Aminomethyl cyclohexane, derivatives thereof and combinations thereof.

17) A process according to claim 14 wherein the ratio of the at least one secondary polyetheramine to the at least one aspartic ester amine ranges from about 5:95 to about 75:25.

18) A process according to claim 14 wherein the ratio of the at least one secondary polyetheramine to the at least one aspartic ester amine ranges from about 1:99 to about 40:60.

19) A process of claim 14 wherein the first component, second component, or first component and second component further comprise at least one polyol.

20) A viscosity reduced amine mixture comprising at least one aspartic ester amine and at least one secondary polyetheramine.
